(19) United States
(12) Patent Application Publication
(10) Pub. No.: US 2024/0180191 A1
(43) Pub. Date: Jun. 6, 2024

(54) METHOD OF PRODUCING PROTEIN ISOLATE FROM SUNFLOWER MEAL

(71) Applicant: TARSHYN&CO LIMITED, London (GB)

(72) Inventors: Oleksii Ivanovych VORONTSOV, Sumy (UA); Stanislav Ivanovych TARSHYN, Kyiv (UA)

(21) Appl. No.: 18/442,928

(22) Filed: Feb. 15, 2024

Related U.S. Application Data
(63) Continuation of application No. PCT/UA2022/000044, filed on Aug. 17, 2022.

(30) Foreign Application Priority Data
Aug. 19, 2021 (UA) A 2021 04736

(51) Int. Cl. A23J 3/14

(52) U.S. Cl. CPC A23J 3/14

(57) ABSTRACT

A method of producing a protein isolate from sunflower meal is provided, including milling the meal, washing out the milled meal with an acid followed by separating a solvent, extracting a produced product with an alkali followed by separating a protein solution, isoelectrically depositing the protein with the acid, washing out a produced deposit with water and the acid followed by depositing, neutralizing a suspension of the produced product to a pH of 7.0, stabilizing the produced suspension by heating and spray drying the suspension to produce the protein isolate.

### CROSS REFERENCE TO RELATED APPLICATION

This application is a continuation of International Application No. PCT/UA2022/000044, filed Aug. 17, 2022. Which claims the benefit of Ukraine Patent Application No. a 2021 04736, filed Aug. 19, 2021 the contents of each of which are incorporated by reference herein in its entirety.

### FIELD OF THE INVENTION

The invention relates to producing a protein isolate from defatted sunflower meal that can be used in the food industry, for example, as a food additive or stabilizer, or as the main food component in the production of meat and fish plant analogues, functional drinks, sauces, mayonnaises, bakery products, as well as in the production of vegetable milk, fermented milk products, and cheeses.

### BACKGROUND

At present, plant raw materials which are a source of valuable natural substances such as protein are actively used to meet the nutritional needs of humans and animals. Also, an additional source of valuable natural substances is a significant amount of by-products formed during the processing of plant raw materials.

Sunflower seed is the main oil crop of Ukraine. The main product of sunflower seed processing is vegetable oil. The by-product of sunflower seed processing, i.e., meal, is used only as a raw material for producing feed additives for feeding poultry and livestock. In addition, sunflower seeds are an important source of proteins that have the high nutritional value. Sunflower protein is characterized by a balanced amino acid composition (excluding lysine) acceptable for humans, is hypoallergenic and perfectly digestible and can serve as an alternative to soy protein, pea protein, and wheat gluten in the food industry.

Sunflower protein, as for the amino acid composition thereof, is advantageously differs from wheat gluten, being inferior to the latter only in the content of glutamic acid and proline that are replaceable amino acids; slightly inferior to pea protein in the content of aspartic acid, serine and tyrosine that are replaceable amino acids, and leucine and threonine, and significantly to lysine, which are essential amino acids; it is also slightly inferior to soy protein in the content of tyrosine, proline, serine, aspartic acid that are replaceable amino acids, and threonine and leucine, and significantly to lysine, that are essential amino acids, which in turn is close to proteins of animal origin in terms of the biological value thereof. However, in spite of the existing differences, the amino acid composition of sunflower protein indicates the feasibility of the use thereof in food production to increase the biological value of food products.

In 2019, the global vegetable protein market was valued at approximately USD 11.6 billion, with an expected growth to USD 18.1 billion in 2024. Soy products dominate at the market and are 58% of the market. The growth of the world's population, the increase in the need for food, and the growing trend towards a non-meat diet create the conditions for a stable and growing demand for vegetable proteins. But most of the agricultural crops, from which vegetable proteins are produced, are genetically modified or have allergenic compounds, so they are negatively treated by consumers.

At the same time, worldwide demand for “natural” and “organic” products is increasing. The launch of new products labeled as non-GMO and/or organic is increasing worldwide. And sunflower is promising in this regard, because sunflower is the only 100% non-GMO oil crop in the world, and this status will be preserved for sunflower in the near future for two main reasons: first, it's difficult for sunflower to undergo genetic modification because the plant is resistant to genetic modifications, and second, genetic modifications of sunflower cannot be approved by the regulatory authorities of the United States and other countries because of the significant negative consequences of such modifications. This cross-pollinated crop originating from North America has “wild” relatives all over the world—in Europe, Australia, Africa, Argentina, etc. The spread of genetically modified sunflower varieties in these regions may result in gene exchanging with wild species. Transgenes from a cultivated plant can transfer to wild or weedy populations, increasing their adaptability to different conditions and modifying them. To the contrary, wild or weedy sunflowers and self-sowing plants can cross-pollinate cultivated plants, which can significantly change some of their valuable characteristics, including oil composition, etc.

Accordingly, at present, there is a need for the production of non-GMO sunflower protein isolate that would find application in the food industry, i.e., in the production of meat and fish plant analogues, functional drinks, sauces, mayonnaises, bakery products, as well as in the production vegetable milk, fermented milk products, and cheeses.

Due to the fact that the produced protein product should meet certain requirements for products used in the food industry, sunflower protein has to be purified from accompanying undesirable non-nutritive substances and, depending on the degree of purity, may be presented in the form of concentrates or isolates. In addition, sunflower protein isolates should meet a number of different requirements of the food industry regarding solubility, emulsification and gelation, exclusion of components considered undesirable such as chlorogenic acid, as well as organoleptic properties, and, in particular, color.

In addition, sunflower meal, in addition to chlorogenic acid, contains other phenolic compounds, i.e.: sinapic acid, caffeic acid, isoferulic acid, cinnamic acid, coumaric acid. The negative effect of high concentrations of chlorogenic acid is demonstrated in the darkening of the extracted sunflower protein color.

Methods of extracting plant proteins in industry include extraction with the use of alkalies, acids, enzymes or salt solutions followed by separation of the extract. Next, the protein is separated from accompanying components and concentrated.

For example, U.S. Pat. No. 4,435,319 provides a method of producing a protein isolate from sunflower meal, including the following stages: (1) treating a sunflower meal suspension with an acid at a pH of 4.0 to 7.0; (2) separating an insoluble residue from a protein extract; (3) resuspending the insoluble residue and sequentially repeating stages (1) and (2) with respect to the residue until the desired decolorization is achieved; (4) resuspending and treating the insoluble residue with an acid at a pH <4.0; (5) separating the insoluble residue from the protein extract; (6) repeating stages (4) and (5); (7) combining the protein extract from stages (2), (3), (5), and (6) and isolating the protein by acid deposition or ultrafiltration.

The disadvantages of the disclosed method include a large number of stages and the formation of a large amount of washing water that needs to be processed, a rather low yield of the final product, and the dark color thereof.

Patent RU2218811 disclosed a method of producing a protein concentrate from sunflower meal, which includes extracting a protein from the meal with a solution including sodium chloride and sodium hydroxide, isolating an extract, treating the extract with a muriatic acid solution at a pH of 3-4 with protein depositing, isolating an insoluble protein deposit, drying thereof using spray drying in air.

The disadvantages of the provided method include the low protein content in the produced concentrate and the gray color of the produced product.

Patent RU2340203 provided a method of producing a food protein isolate from sunflower meal, including extracting a protein from the meal using an aqueous solution of sodium chloride, separating an insoluble deposit by filtration to produce an extract, treating the extract with an acid-type reagent to deposit proteins and bind phenolic compounds, separating, by centrifugation, the solid and liquid phases, washing out and drying the solid residue, where an aqueous solution of succinic acid with a concentration of 3-5% and a ratio of weight parts of the extract and succinic acid of 1:10-1:12 is used as the acid-type reagent, depositing with stirring for 20-30 minutes and at a temperature of 45-55° C.

According to the data given in RU2340203, the provided method made it possible to reduce the content of chlorogenic acid and caffeic acid to 0.015-0.022%, but the total protein content in the product was only 88.1% based on absolutely dry matter, which is insufficient to classify the produced product as an isolate, in which the content of the main product (protein) should be more than 90% based on absolutely dry matter.

For example, UA111302C2 discloses a method of producing proteins from sunflower meal, including: milling the meal, extracting proteins in a sodium chloride solution according to hydromodule 1:(8-10) with additional physical treatment, separating solid particles of the meal from a protein extract by centrifugation, isoelectric deposition of proteins from the extract by adding a muriatic acid solution to a pH value of 4.0-4.6 followed by separation of a protein paste by centrifugation, in which the physical treatment during the extraction of proteins from the meal is used as the periodic effect of ultrasonic vibrations in a cavitation mode at the output acoustic power of a generator of 10 W, frequency interval of 44 kHz and duration of ultrasonic treatment of 3 to 6 minutes.

The main attention in the above-described method of producing proteins from sunflower meal was paid to increasing the amount of extracted proteins, but the inventors ignored the issue of the purity of the produced protein isolate and the reduction of the content of phenolic compounds that give the isolate produced in this way a grayish color.

Therefore, there is a need for a modern method of producing the protein isolate from sunflower meal, which has a protein content of more than 90% based on absolutely dry matter, devoid of phenolic compounds such as, in particular, chlorogenic acid, which gives the protein isolate a dark color.

The currently known methods of producing the protein isolate from sunflower meal fail to meet the high quality requirements for the protein isolate suitable for use in the food industry.

Accordingly, an objective of the invention was to develop a method of producing a food protein isolate from sunflower meal, which would ensure producing the isolate with a protein content of more than 90% based on absolutely dry matter, have a low content of phenolic compounds and high quality indicators regarding the purity of the product, functional and organoleptic properties, color and appearance thereof.

### SUMMARY

The objective is reached by the developed method of producing the protein isolate from sunflower meal, including:
(a) milling sunflower meal;
(b) washing out the milled sunflower meal using an acid followed by separating a solvent;
(c) alkali extracting a produced product followed by separating a protein solution;
(d) isoelectrically depositing protein from the solution using the acid;
(e) washing out a produced deposit with water and the acid followed by separating the solvent;
(f) neutralizing a suspension of the produced product to a pH of 7.0;
(g) stabilizing the produced suspension by heating, and
(h) spray drying the suspension to produce the protein isolate.

In one of the embodiments of the invention, the milled sunflower meal at stage (b) is washed out with the acid at a pH of 4.0-4.9 with a sunflower meal:water ratio of 1:9-10 for 15-45 minutes at a temperature of 45 to 70° C.

In another embodiment of the invention, the milled sunflower meal at stage (b) is washed out with a 10% acid at a pH of 4.5 for 30 minutes at a temperature of 50 to 60° C.

In another embodiment of the invention, the milled sunflower meal at stage (b) is washed out at a temperature of 55° C.

In another embodiment of the invention, separating the solvent at stage (b) is carried out using decantation.

In another embodiment of the invention, acid washing out at stage (b) is carried out in the presence of an antioxidant.

In another embodiment of the invention, sodium sulfite is used as an antioxidant at stage (b).

In another embodiment of the invention, the protein produced at the previous stage (b) is extracted with an alkali at a pH of 9.5 for 15-45 minutes at a temperature of 45 to 70° C.

In another embodiment of the invention, protein extracting at stage (c) is carried out for 30 minutes at a temperature of 50 to 60° C.

In another embodiment of the invention, protein extracting at stage (c) is carried out at a temperature of 55° C.

In another embodiment of the invention, separating an insoluble residue at stage (c) is carried out by decantation.

In another embodiment of the invention, alkali extracting at stage (c) is carried out in the presence of an antioxidant.

In another embodiment of the invention, sodium sulfite is used as an antioxidant at stage (c).

In another embodiment of the invention, isoelectrically depositing the protein at stage (d) is carried out by lowering a pH to 4.0-5.0 with the acid.

In another embodiment of the invention, isoelectrically depositing the protein at stage (d) is carried out by lowering a pH to 4.5 with the acid.

In another embodiment of the invention, isoelectrically depositing the protein at stage (d) is carried out using a 10% acid for 15-45 minutes at a temperature of 45 to 70° C.

In another embodiment of the invention, isoelectrically depositing the protein at stage (d) is carried out for 30 minutes at a temperature of 50 to 60° C.

In another embodiment of the invention, isoelectrically depositing the protein at stage (d) is carried out at a temperature of 55° C.

In another embodiment of the invention, separating the solvent at stage (d) is carried out by centrifuging.

In another embodiment of the invention, washing out at stage (e) is carried out with water, and then with an acid with a pH of about 4.0-5.0 at a temperature of 50 to 60° C.

In another embodiment of the invention, washing out at stage (e) is carried out for 10 minutes with an acid with a pH of 4.5 at a temperature of 55° C.

In another embodiment of the invention, the protein at stage (e) is deposited by centrifugation at 17,000 g.

In another embodiment of the invention, the protein from stage (e) is resuspended in water and neutralized to a pH of 7.0.

In another embodiment of the invention, neutralizing at stage (f) is carried out by adding an alkali.

In another embodiment of the invention, neutralizing at stage (f) is carried out by adding an 8% alkali solution.

In another embodiment of the invention, neutralizing at stage (f) is carried out for 30 minutes at a temperature of 45 to 70° C.

In another embodiment of the invention, neutralizing at stage (f) is carried out at a temperature of 50° C.

In another embodiment of the invention, the suspension at stage (g) is heated to a temperature of 70 to 95° C. for 15-60 seconds.

In another embodiment of the invention, the suspension at stage (g) is heated to a temperature of 85° C. for 30 seconds.

In another embodiment of the invention, the protein isolate is produced by spray drying the suspension at a temperature of 80 to 180° C.

The combination of acid washing out, alkaline extracting, isoelectrically depositing, washing out, neutralizing, heat treatment and spray drying under the above conditions made it possible to produce the protein isolate with excellent qualitative and quantitative characteristics, which is suitable for use in the food industry.

The features of the developed method may include the introducing, at the stages, both acid and alkaline extraction of an antioxidant such as sodium sulfite, which positively affects the quality of the product produced, preventing the oxidation of the target product during the acid and alkaline extraction.

Although the individual stages of the provided method were known from the art, their combination in this sequence, with the selection of optimal conditions for carrying out these stages, i.e., reagents, pH, temperature regime, pressure, made it possible to provide for an optimal method of producing the protein isolate from sunflower meal, which provides for a product with exceptional qualitative and quantitative characteristics.

The produced protein isolate was in the form of a finely dispersed white powder with a light cream shade and a protein content of 91-94% based on absolutely dry matter. Such a high degree of protein isolation was exceptional for this art, and the purity of the produced protein isolate allows the use thereof in the food industry without additional purification.

### DETAILED DESCRIPTION OF THE PREFERRED EMBODIMENTS

Next, the provided method of producing the protein isolate from sunflower meal is disclosed in more detail with the disclosure of the details of the developed method.

At stage (a) of the provided method, milling the sunflower meal is carried out. Such milling may be carried out on any suitable equipment that may be acceptable and available in the art. Sunflower meal is milled to a particle size of less than 0.5-1 mm using a ball mill or other suitable equipment.

Milling sunflower meal is designed to improve the dispersion of the meal and the extraction of protein from the meal. It is quite obvious that if the raw meal has the size defined above and does not contain large particles, such milling may not be required, but generally the particles of sunflower meal produced after oil extraction have significant sizes and, therefore, require additional milling.

At stage (b) of the provided method, the produced milled sunflower meal is mixed with softened water when constantly stirred. Softened water is produced by demineralization thereof to prevent the formation of metal salts with phenolic compounds present in sunflower meal. Softened water can be produced using any method acceptable and available in the art, for example, by distillation or passing through an ion exchange resin. The sunflower meal:water ratio is 1:9-10. After mixing with water, an antioxidant and an acid are added to the produced mixture to a pH in a range of 4.0 to 4.9, preferably 4.5, the mixture is heated to a temperature of about 50-55° C. and stirred under these conditions for about 30 minutes for complete extraction of phenolic compounds and, in particular, chlorogenic acid, and other substances soluble in an acidic media.

Any compound suitable and acceptable in the art may be used as an antioxidant. The presence of the antioxidant in the solution should prevent the oxidation of organic compounds present in the solution with air oxygen and reduce the contamination of the target protein with oxidation products, since the extraction is carried out at elevated temperature in an acidic environment. In particular, the compounds such as sodium sulfite, ascorbic acid, butylhydroxytoluene, butylhydroxyanisole, etc. may be used as an antioxidant. Sodium sulfite is preferred in this method. The content of the antioxidant may be 0.05 wt. % to 0.3 wt. %, preferably 0.1 wt. % of the weight of the entire solution.

As an acid for extraction in this method, any acid suitable and acceptable in the art may be used. Examples of acids include both inorganic and organic acids. Examples of inorganic acids include hydrochloric acid, hydrobromic acid, hydroiodic acid, sulfuric acid, phosphoric acid, nitric acid, etc. Examples of organic acids include acetic acid, lactic acid, succinic acid, malonic acid, oxalic acid, etc. In this method, hydrochloric acid is preferred, which is used as a 10% solution in water (sometimes also referred to as muriatic acid).

After the extraction of phenolic compounds is completed, the produced mixture is subjected to decantation to deposit insoluble substances. Decantation may be carried out by ordinary settling or using mechanical means, in particular, decanters equipped with a centrifuge. In this case, decantation is carried out at 4000 g of atmospheric pressure and for 2 to 10 minutes, preferably for 5 minutes.

After decantation, the supernatant liquid which is an extract of phenolic compounds, is drained, and the residue is used at the next stage.

At stage (c) of the provided method, the extracted suspension produced at the previous stage is mixed with softened water with constant stirring. The suspension: water ratio is 1:3-4. After mixing with water, an antioxidant and alkali are added to the produced mixture to a pH in the range of 9.0 to 10.0, preferably about 9.5-9.6, the mixture is heated to a temperature of about 50-55° C. and stirred under these conditions for about 30 minutes for complete dissolution of the protein fraction.

At this stage, any suitable and acceptable compound in the art may be used as an antioxidant. In particular, the compounds such as sodium sulfite, ascorbic acid, butylhydroxytoluene, butylhydroxyanisole, etc. may be used as an antioxidant. Preferred in this method is sodium sulfite. The content of the antioxidant may be 0.05 wt. % to 0.3 wt. %, preferably 0.1 wt. % of the weight of the entire solution.

As an alkali to provide for the dissolution of the protein fraction in this method, any base suitable and acceptable in this art may be used. Examples of alkali include both inorganic and organic alkalies. Examples of inorganic alkalies include hydroxides such as lithium hydroxide, sodium hydroxide, potassium hydroxide, barium hydroxide, etc., carbonates and hydrocarbonates such as lithium carbonate and hydrocarbonate, sodium carbonate and hydrocarbonate, potassium carbonate and hydrocarbonate, etc. Examples of organic alkalies include amines such as tertiary amines, i.e.: tri-C1-C6-alkylamines such as triethylamine, trimethylamine, N-ethyldiisopropylamine and N-methylpiperidine, pyridine, substituted pyridines such as collidine, lutidine, N-methylmorpholine, and bicyclic amines such as 1,8-diazabicyclo[5.4.0]undec-7-ene or 1,5-diazabicyclo[4.3.0]non-5-ene. In this method sodium hydroxide is preferred, which is used as an 8% solution in water.

After the protein extraction is completed, the produced mixture is subjected to decantation to deposit insoluble substances such as fiber, carbohydrates, minerals, etc. Decantation may be carried out by ordinary settling or using mechanical means, in particular, decanters equipped with a centrifuge. In this case, decantation is carried out at 4000 g of atmospheric pressure and for 2 to 10 minutes, preferably for 5 minutes.

After decantation, the supernatant liquid which is a protein extract is separated and used at the next stage.

The use of an antioxidant such as sodium sulfite at both stages of acid and alkaline extraction significantly reduces the oxidation of the processed product with air oxygen and reduces the color of the produced extracts, which positively affects the quality of the final protein isolate.

At stage (d) of the provided method, an acid is slowly added to the protein extract produced at the previous stage at a temperature of about 55° C. with constant stirring, bringing a pH of the solution to about 4.5, and the produced mixture is stirred for about 30 minutes, while maintaining a temperature of about 55° C. After the completion of the isoelectric deposition of the protein, the aqueous solution is separated by centrifugation at 17,000 g, producing a concentrated protein suspension in the residue.

As an acid for the isoelectric deposition at this stage of the method, any acid suitable and acceptable in the art may be used. Examples of acids include both inorganic and organic acids. Examples of inorganic acids include hydrochloric acid, hydrobromic acid, hydroiodic acid, sulfuric acid, phosphoric acid, nitric acid, etc. Examples of organic acids include acetic acid, lactic acid, succinic acid, malonic acid, oxalic acid, etc. In this method, hydrochloric acid is preferred, which is used in the form of a 10% solution in water (sometimes also referred to as muriatic acid).

At stage (e) of the provided method, the protein suspension produced at the previous stage is mixed with softened water in a ratio of 1:3, respectively, and stirred while heating to a temperature of 50-60° C., bringing a pH of the mixture to about 4.5 by adding an acid to the mixture, and the produced mixture is stirred for another 10 min. After the washing out is completed, the aqueous solution is separated by centrifugation at 17,000 g, producing in the residue a concentrated protein suspension having a pH of about 4.5-5.0.

Hydrochloric acid as a 10% solution in water is also used as an acid at this stage.

At the next stage (f), the produced concentrated protein suspension is loaded into a tank and mixed with softened water in a ratio of 1:0.35, heated to a temperature of about 50-60° C., and, with constant stirring, alkali is added, bringing a pH to neutral, about 7,0-7,1, and the produced mixture is mixed for 20-30 minutes, and then is subjected to sterilization, stage (g), by rapidly heating to a temperature of about 80-90° C. for 30 seconds.

Sterilization at a temperature of 80-90° C. is required to prevent microbiological contamination of the product produced and to increase shelf life thereof.

At stage (f), sodium hydroxide which is used as an 8% solution in water is used as an alkali.

The protein suspension with a pH of about 7.0-7.1 produced at stage (g) is dried by spraying at a temperature of 80 to 180° C. and a pressure of 1 to 2 bar to obtain a dry protein isolate as a finely dispersed white powder with a light cream shade. The protein content in the produced product was 91-94% based on absolutely dry matter. At the same time, the content of dry substances in the produced product was about 96%.

The provided method of producing the protein isolate from sunflower meal made it possible to optimize:
the use of an antioxidant in the process of processing sunflower meal, thereby reducing the coloration of the protein isolate by oxidation by-products at the stage of acid and alkaline extraction;
the process of extracting phenolic compounds from sunflower meal;
the process of protein extraction and separation thereof from working solutions;
the temperature regime of sunflower meal processing.

All the listed innovations made it possible to significantly increase the level of protein extraction from sunflower meal, the content thereof in the final product, and significantly improve the appearance of the produced protein isolate.

The description of the method of producing the protein isolate from sunflower meal in a pilot project is provided below.

### Milling and Acid Washing Out:

40 kg of sunflower meal are milled to a particle size of less than 0.5-1 mm and mixed with 360 liters of softened water. The mixture is heated to a temperature of 55° C., 0.4 kg of sodium sulfite and 5.4 kg of a 10% solution of hydrochloric acid are added to the mixture, and the produced mixture is stirred for 30 minutes and a pH in the range of 4.4 to 4.9, while maintaining the temperature in the range of 50-55° C. After the extraction is complete, the phenolic extract is separated by decantation at 4000 g to produce 91.5 kg of the protein suspension in the residue.

Washing Out with Alkali:

91.5 kg of protein suspension from the previous stage is mixed with 308 liters of softened water. The mixture is heated to a temperature of 55° C., 0.4 kg of sodium sulfite and 7.3 kg of an 8% sodium hydroxide solution are added to the mixture, and the produced mixture is stirred for 30 minutes and at a pH in the range of 9.5 to 9.6, while maintaining the temperature in the range of 50-55° C. After the extraction is complete, the protein extract is separated by decantation at 4000 g to produce 371.0 kg of the protein extract and a residue consisting of insoluble fibers, which is discarded.

### Isoelectric Deposition:

3.6 kg of the 10% hydrochloric acid solution is slowly added to 371.0 kg of the protein extract from the previous stage at a temperature of about 53-55° C. with constant stirring and the produced mixture is stirred for 30 minutes and at a pH of about 4.5, while maintaining a temperature of about 53-55° C. After the extraction is completed, the aqueous solution is separated by centrifugation at 17,000 g to produce 94.4 kg of the protein suspension in the residue.

### Washing Out:

94.4 kg of the protein suspension from the previous stage is mixed with 284 liters of softened water. The mixture is heated to a temperature of 55° C., 0.6 kg of the 10% hydrochloric acid solution is added to the mixture, and the produced mixture is stirred for 10 minutes and at a pH of about 4.5, while maintaining a temperature of about 55° C. After washing out is completed, the aqueous solution is separated by centrifugation at 17,000 g to produce 76.9 kg of the protein suspension in the residue.

### Neutralization and Stabilization:

76.9 kg of the protein suspension from the previous stage is mixed with 27 liters of softened water. The mixture is heated to a temperature of 50° C. and, with constant stirring, about 1.8 kg of the 8% sodium hydroxide solution is added to the mixture, bringing a pH to about 7.0, the produced mixture is stirred for 20-30 minutes and then heated to a temperature of about 85° C. for 30 seconds to produce about 100 kg of the protein suspension.

### Drying:

100 kg of the protein suspension from the previous stage is subjected to spray drying at a temperature of 80 to 180° C. and a pressure of 1 to 2 bar to produce 4.3 kg of the protein isolate as a finely dispersed white powder with a light cream shade. The protein content of the produced product was 92.2% based on absolutely dry matter. At the same time, the content of dry substances in the produced product was about 96%.

The developed method of producing the protein isolate from defatted sunflower meal is well reproducible and provides for producing the protein isolate with the protein content of 91-94% based on absolutely dry matter and excellent quality characteristics, which allows the use of this method on an industrial scale.

What is claimed is:

1. A method of producing a protein isolate from sunflower meal, comprising:
(a) milling the meal,
(b) washing out the milled meal using an acid followed by separating a solvent,
(c) alkali extracting the produced product followed by separating a protein solution,
(d) isoelectrically depositing protein from the solution using the acid,
(e) washing out a produced deposit with water and the acid followed by separating the solvent,
(f) neutralizing a suspension of the produced product to a pH of 7.0,
(g) stabilizing the produced suspension by heating, and
(h) spray drying the suspension to produce the protein isolate,
wherein stages (b) and (c) are carried out in the presence of an antioxidant.

2. The method of claim 1, wherein the meal at stage (b) is washed out with a 10% hydrochloric acid at a pH of 4.0-4.9, with a sunflower meal:water ratio of 1:9-10 for 15-45 minutes at a temperature of 45 to 70° C.

3. The method of claim 1, wherein the milled meal at stage (b) is washed out with the acid at a pH of 4.5 for 30 minutes at a temperature of 50 to 60° C.

4. The method of claim 1, wherein the milled meal at stage (b) is washed out at a temperature of 55° C.

5. The method of claim 1, wherein depositing at stage (b) is carried out by decantation.

6. The method of claim 1, wherein sodium sulfite is used as an antioxidant at stage (b).

7. The method of claim 1, wherein the protein produced at stage (b) is extracted with alkali at a pH of 9.5 for 15-45 minutes at a temperature of 45 to 70° C.

8. The method of claim 1, wherein protein extracting at stage (c) is carried out for 30 minutes at a temperature of 50 to 60° C.

9. The method of claim 1, wherein protein extracting at stage (c) is carried out at a temperature of 55° C.

10. The method of claim 1, wherein separating an insoluble residue at stage (c) is carried out by decantation.

11. The method of claim 1, wherein sodium sulfite is used as an antioxidant at stage (c).

12. The method of claim 1, wherein isoelectrically depositing the protein at stage (d) is carried out by lowering a pH to 4.0-5.0 using the acid.

13. The method of claim 1, wherein isoelectrically depositing the protein at stage (d) is carried out by lowering a pH to 4.5 using the acid.

14. The method of claim 1, wherein isoelectrically depositing the protein at stage (d) is carried out with a 10% hydrochloric acid for 15-45 minutes at a temperature of 45 to 70° C.

15. The method of claim 1, wherein isoelectrically depositing the protein at stage (d) is carried out for 30 minutes at a temperature of 50 to 60° C.

16. The method of claim 1, wherein isoelectrically depositing the protein at stage (d) is carried out at a temperature of 55° C.

17. The method of claim 1, wherein depositing at stage (d) is carried out by centrifugation.

18. The method of claim 1, wherein washing out at stage (e) is carried out with water and then with acid at a pH of about 4.0-5.0 and a temperature of 50 to 60° C.

19. The method of claim 1, wherein washing out at stage (e) is carried out for 10 minutes with the acid at a pH of 4.5 and a temperature of 55° C.

20. The method of claim 1, wherein the protein at stage (e) is deposited by centrifugation at 17,000 g.

21. The method of claim 1, wherein the protein from stage (e) is resuspended in water and neutralized to a pH of 7.0.

22. The method of claim 1, wherein neutralizing at stage (f) is carried out by adding an alkali.

23. The method of claim 1, wherein neutralizing at stage (f) is carried out by adding a sodium hydroxide.

24. The method of claim 1, wherein neutralizing at stage (f) is carried out by adding an 8% sodium hydroxide solution.

25. The method of claim 1, wherein neutralizing at stage (f) is carried out for 30 minutes at a temperature of 45 to 70° C.

26. The method of claim 1, wherein neutralizing at stage (f) is carried out at a temperature of 50° C.

27. The method of claim 1, wherein the suspension at stage (g) is heated to a temperature of 70 to 95° C. for 15-60 seconds.

28. The method of claim 1, wherein the suspension at stage (g) is heated to a temperature of 85° C. for 30 seconds.

29. The method of claim 1, wherein the protein isolate is produced using drying the suspension by spraying at a temperature of 80 to 180° C.
